(19) United States
(12) Patent Application Publication
(10) Pub. No.: US 2020/0194907 A1
(43) Pub. Date: Jun. 18, 2020

(54) WIRE CONNECTION STRUCTURE AND HARNESS MANUFACTURING METHOD

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(72) Inventors: Kazuhiro Washio, Yokkaichi, Mie (JP); Kenji Miyamoto, Yokkaichi, Mie (JP); Yuji Kawata, Yokkaichi, Mie (JP)

(21) Appl. No.: 16/608,340

(22) PCT Filed: Apr. 18, 2018
(86) PCT No.: PCT/JP2018/015950

§ 371 Date: Oct. 25, 2019

(30) Foreign Application Priority Data
Apr. 28, 2017 (JP) 2017-090120

(51) Int. Cl. H01R 4/18; H01R 43/048

(52) U.S. Cl. CPC H01R 4/184; H01R 43/048

(57) ABSTRACT

A harness 1 is provided with a wire 10 including a core 11 constituted by a plurality of strands and an insulation coating 12 coating the core 11, a single-core wire 20 including a body portion 21 and a wire fixing portion 23 extending from the body portion 21 and arranged to cover the core 11, and a splice terminal 30 including a bottom plate portion 31, the core 11 being arranged on the bottom plate portion 31, and a pair of wire barrel portions 32 extending from the bottom plate portion 31 and wound from outside the wire fixing portion 23. According to this configuration, since the wire fixing portion 23 of the single-core wire 20 is interposed between the core 11 and the wire barrel portions 32, it can be avoided that the core 11 protrudes from butting parts of the pair of wire barrel portions 32.

### BACKGROUND

### Field of the Invention

This specification relates to a wire connection structure and a harness manufacturing method.

### Related Art

Japanese Unexamined Patent Publication No. 2013-25997 discloses a wire connection structure in which a round bar wire and a stranded wire are connected. The round bar wire includes a conductor formed into a flat plate body. On the other hand, the stranded wire includes a conductor formed by twisting a plurality of strands. A connection is formed by overlapping the conductor of the stranded wire on the conductor of the round bar wire and performing ultrasonic welding.

However, joining by ultrasonic welding is problematic in that the conductor of the stranded wire easily is pulled apart from the conductor of the round bar wire if the stranded wire is pulled upward. On the other hand, crimping barrels to wrap around the conductor of the stranded wire can cause the strands to protrude and a short circuit may occur between circuits due to contact of the protruding strands with another circuit.

### SUMMARY

A wire connection structure disclosed by this specification has a wire, a connecting conductor and a crimping terminal. The wire has a core constituted by a plurality of strands and an insulation coating covering the core. The connecting conductor includes a body and a wire fixing portion extending from the body and arranged to cover the core. The crimping terminal including a bottom wall on which the core is arranged. Two barrels extending from the bottom wall portion and wound from outside the wire fixing portion.

According to the above configuration, the wire fixing portion of the connecting conductor is interposed between the core and the barrels. Thus, the core cannot protrude from butting parts of the barrels.

The wire fixing portion may include a thick portion extending along a circumferential direction of the core and having a larger thickness than other parts. According to the configuration, a part of the core covered with the thick portion serves as a high compression portion and is compressed at a higher compression ratio than the other parts. This high compression ratio breaks an oxide film formed on the surface of the core to expose a new surface of metal. The contact of the crimping terminal and the wire fixing portion with this new surface reduces a contact resistance between the core, the connecting conductor and the crimping terminal. On the other hand, the core is compressed with a lower compression force than in the high compression portion so that breakage of the core is prevented.

The core easily could protrude in the high compression portion. However, the wire fixing portion is between the core and the wire barrels to prevent protrusion of the core.

This specification also relates to a harness manufacturing method for connecting a wire and a connecting conductor by a crimping terminal. The wire includes a core constituted by a plurality of strands and an insulation coating covering the core. The connecting conductor includes a body and a plate-like wire fixing portion extending from the body. The crimping terminal includes a bottom wall, and the core is arranged on the bottom wall. Two barrels extend from the bottom wall. The method includes a setting step of setting the wire fixing portion on the core after the core is set on the bottom wall portion, and a crimping step of winding the barrels around the core from outside the wire fixing portion after the setting step.

According to this configuration, the crimping step does not cause the core to protrude from butting parts of the barrels since the wire fixing portion is interposed between the barrels and the core.

According to the wire connection structure and the harness manufacturing method disclosed by this specification, the core does not protrude from the butting parts of the barrels.

### BRIEF DESCRIPTION OF DRAWINGS

FIG. 1 is a perspective view of a harness of an embodiment.

FIG. 2 is a section along A-A of FIG. 1.

FIG. 3 is a section along B-B of FIG. 1.

FIG. 4 is a perspective view of a splice terminal of the embodiment.

FIG. 5 is a perspective view of a single-core wire of the embodiment.

FIG. 6 is a plan view of the single-core wire of the embodiment.

FIG. 7 is a front view of the single-core wire of the embodiment.

FIG. 8 is a side view of the single-core wire of the embodiment.

FIG. 9 is a perspective view showing a state where a wire and the single-core wire are set in the splice terminal in the embodiment.

FIG. 10 is a section showing the state where the splice terminal, a core and the single-core wire are set in a crimping tool in the embodiment.

FIG. 11 is a section showing a state while the splice terminal is being crimped to the core and the single-core wire by the crimping tool in the embodiment.

FIG. 12 is a section showing a state when the crimping of the splice terminal to the core and the single-core wire by the crimping tool is completed in the embodiment.

### DETAILED DESCRIPTION

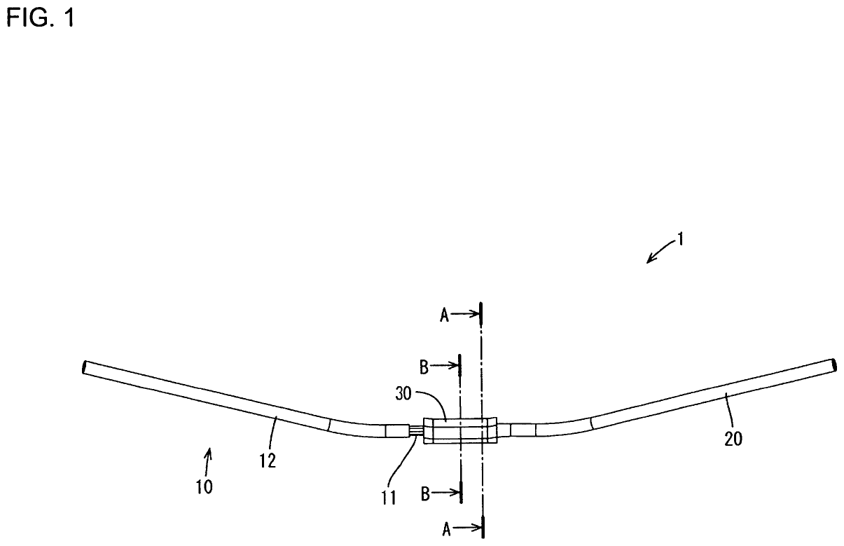

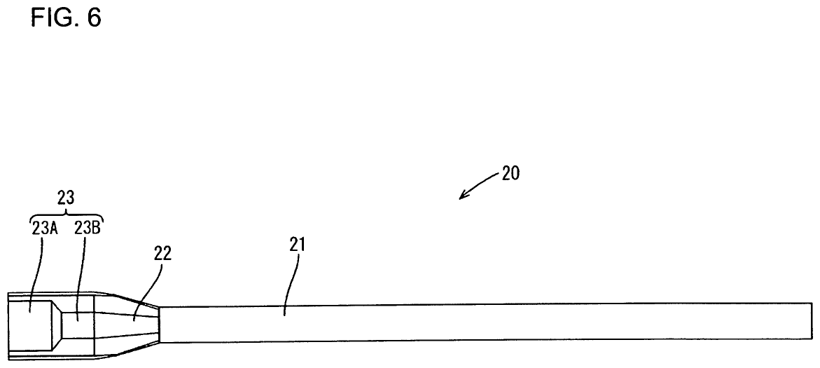

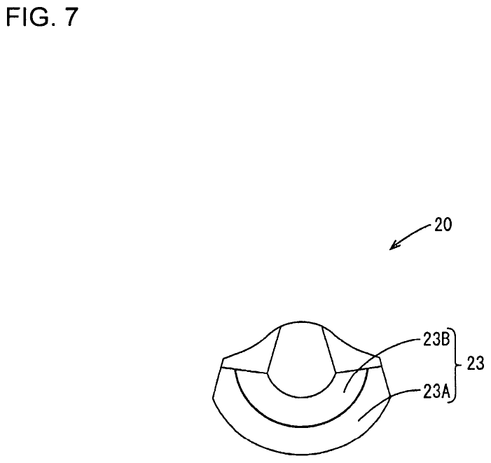

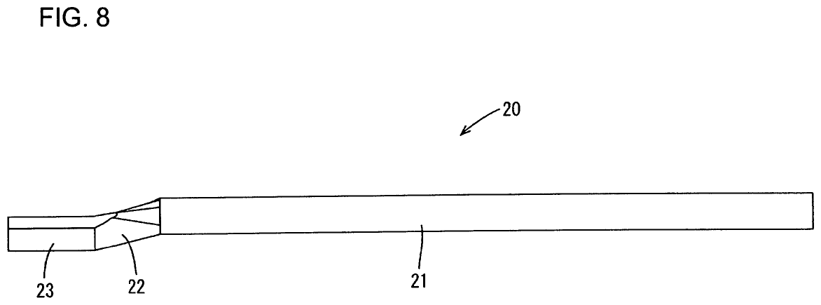

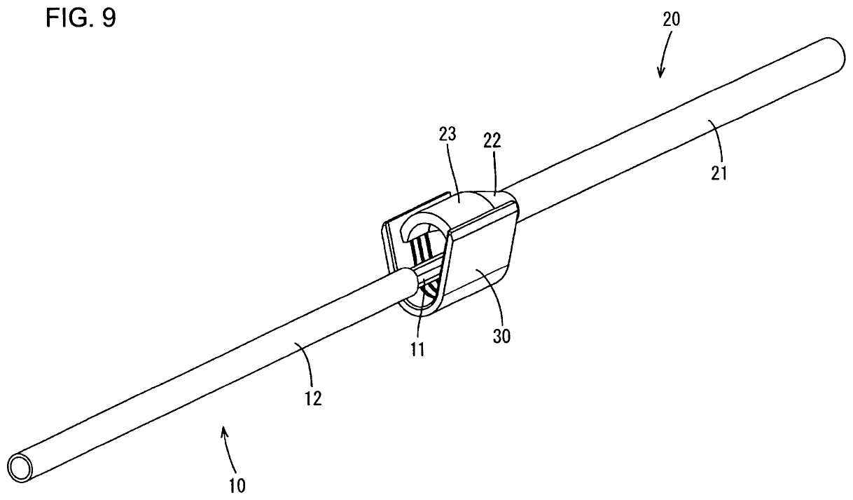

An embodiment is described with reference to FIGS. 1 to 12. A wire connection structure of this embodiment is a part of a harness 1 in which a wire 10 and a single-core wire 20 (corresponding to a connecting conductor) are connected using a splice terminal 30 (corresponding to a crimping terminal), as shown in FIG. 1.

The wire 10 is an aluminum wire of a known configuration including a core 11 and an insulation coating 12. The core 11 is a stranded wire formed by twisting a plurality of strands made of aluminum or aluminum alloy. The insulation coating 12 is made of synthetic resin and coats the core 11. As shown in FIG. 1, the insulation coating 12 is stripped to expose the core 11 at an end part of the wire 10.

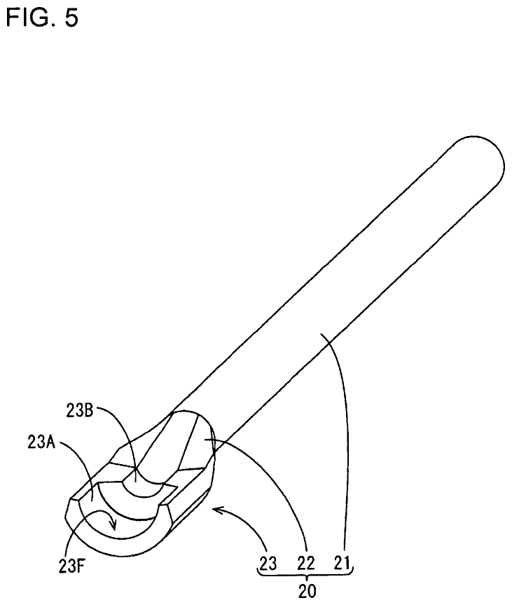

The single-core wire 20 is made of copper or copper alloy and includes, as shown in FIG. 5, a body 21 in the form of a solid round bar and a wire fixing portion 23 connected to one end of the body 21 via a coupling 22. The coupling 22 extends along an axial direction of the body. The wire fixing portion 23 is at the end of the coupling 22 opposite the body and also extends along the axial direction of the body 21.

In a single state of the single-core wire 20 before being connected to the core 11, the wire fixing portion 23 is a plate curved into a semi-cylindrical shape so that a central part between a pair of side edges extending in the direction along the axial direction of the body 21 is convex, and the inner side surface thereof serves as a core contact surface 23F to be brought into contact with the core 11. The wire fixing portion 23 includes a projecting part projecting inward on an end adjacent to the coupling 22, and this one end part serves as a thick portion 23B having a larger thickness than a remaining part (thin portion 23A) on a tip side. In other words, the thick portion 23B of the wire fixing portion 23 is adjacent to the coupling 22 and extends over the entire width in a direction perpendicular to the axial direction of the body. The coupling portion 22 is deformed from the round bar shape of the body 21 to the semi-cylindrical shape of the wire fixing portion 23. This single-core wire 20 can be formed by press-working a tip part of a metal bar material.

The core 11 of the wire 10 and the wire fixing portion 23 of the single-core wire 20 are connected electrically by crimping the splice terminal 30, as shown in FIG. 1.

The splice terminal 30 is formed of a plate material made of copper or copper alloy and tin plating is applied to the surface thereof. In a single state before being crimped to the core 11, the splice terminal 30 is a rectangular plate curved into a U shape, as shown in FIG. 4. A part equivalent to a bottom part of the U shape serves as a bottom wall 31 on which the core 11 is placed at the time of crimping. Parts continuous from this bottom wall 31 and equivalent to two vertical sides of the U shape serve as wire barrels 32 disposed to face each other.

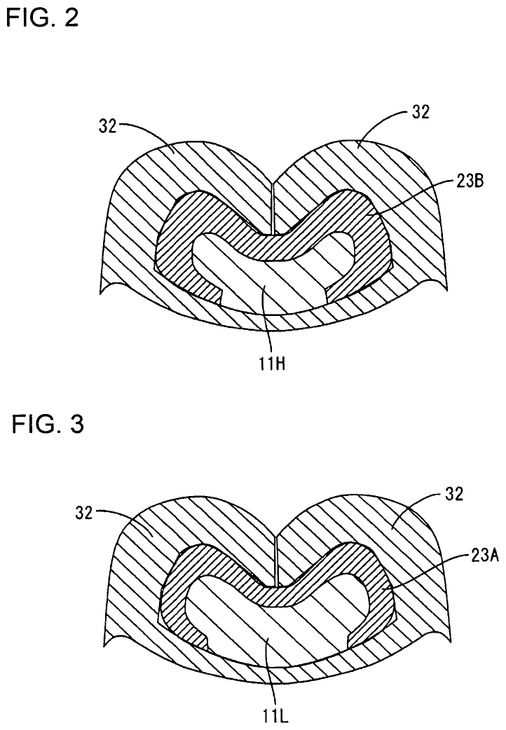

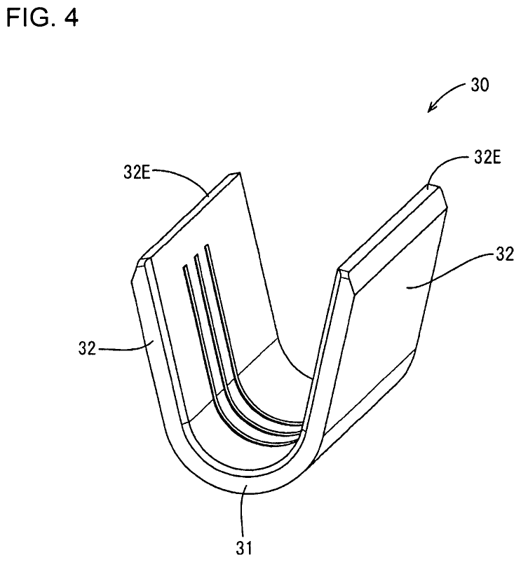

With the splice terminal 30 crimped to the core 11 and the wire fixing portion 23, the core 11 placed on the bottom wall 31 is covered with the wire fixing portion 23 to be enclosed between the bottom plate 31 and the wire fixing portion 23 and, further, the wire barrels 32 are wound from outside the wire fixing portion 23, as shown in FIGS. 2 and 3. In this way, the wire fixing portion 23 is interposed between the core 11 and the wire barrels 32. An extending direction of the wire fixing portion 23 (direction along the axial direction of the body 21) from the coupling 22 extends along an extending direction of the core 11 and the thin portion 23A and the thick portion 23B respectively extend along a circumferential direction of the core 11.

Each wire barrel 32 is curved in such an arched manner as to be convex toward a side opposite to the bottom plate 31. More particularly, the two wire barrels 32 are curved toward each other and bent toward the bottom plate 31 so that end edges 32E bite into the core 11. Tip parts near the end edges 32E of the two wire barrels 32 are butted against each other outside the wire fixing portion 23 (side opposite to the core 11 with respect to the wire fixing portion 23).

A part of the core 11 covered with the thick portion 23B of the wire fixing portion 23 serves as a high compression portion 11H compressed at a higher compression ratio than other parts (low compression portion 11L) (see FIG. 2). In the high compression portion 11H, the core 11 is compressed at the high compression ratio due to the presence of the thick portion 23B. Thus, an oxide film formed on the surface of the core 11 is broken to expose a new surface of metal. This new surface contacts the splice terminal 30 to obtain a desired electrical connection between the core 11, the single-core wire 20 and the splice terminal 30. On the other hand, in a part of the core 11 covered with the thin portion 23A of the wire fixing portion 23 (low compression portion 11L), the core 11 is compressed at a lower compression ratio than in the high compression portion 11H (see FIG. 3) so that breakage of the core 11 is suppressed.

Note that FIGS. 2 and 3 schematically show the core 11 as a whole.

An example of a process of crimping this splice terminal 30 to the core 11 and the wire fixing portion 23 is described below.

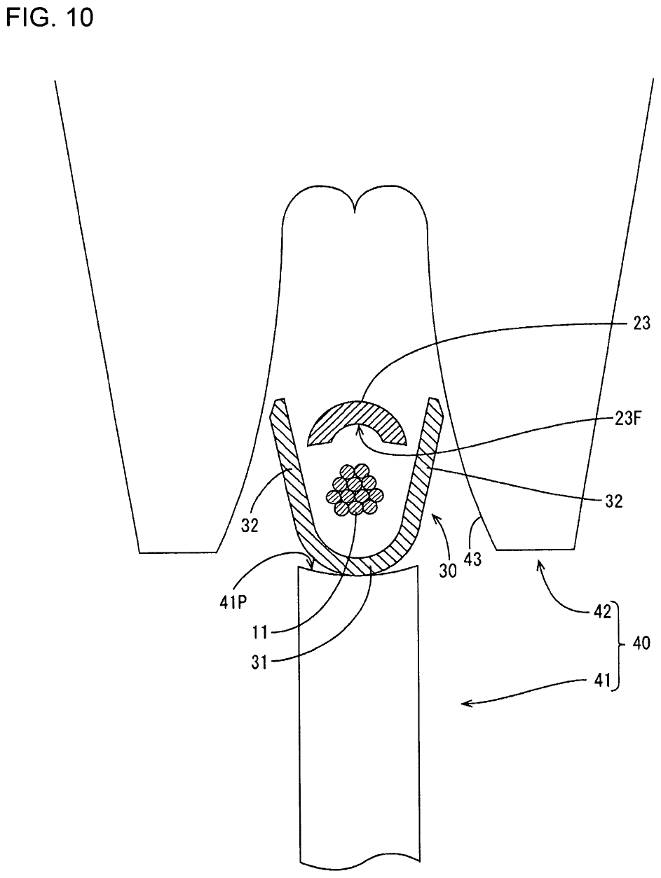

A crimping tool 40 for crimping the splice terminal 30 to the core 11 and the wire fixing portion 23 is composed of an anvil 41 and a crimper 42, as shown in FIG. 10. The anvil 41 is a base on which the splice terminal 30 is placed. The crimper 42 faces the anvil 41 and winds the wire barrels 32 around both the core 11 and the wire fixing portion 23 by sandwiching and curving the wire barrels 32 between the anvil 41 and the crimper 42.

The anvil 41 is a base made of metal and, as shown in FIG. 10, the upper surface thereof serves as a placing surface 41P on which the splice terminal 30 is placed. The placing surface 41P is a concave surface in conformity with the curved shape of the bottom plate 31.

The crimper 42 is a thick metal plate arranged above the anvil 41 to face the anvil 41, and is arranged vertically with respect to the anvil 41 (in an orientation to be perpendicular to the placing surface 41P). As shown in FIG. 10, the crimper 42 includes a tunnel-like part recessed at a position corresponding to the curved surface of the anvil 41 and configured to receive the splice terminal 30 and a part of the anvil 41 inside at the time of crimping. An inner wall of this tunnel-like part serves as a barrel pressing wall 43 for pressing the wire barrels 32 at the time of crimping.

The splice terminal 30 is crimped to the core 11 and the wire fixing portion 23 using this crimping tool 40 by placing the splice terminal 30 on the placing surface 41P of the anvil 41, as shown in FIG. 10. Subsequently, the core 11 is arranged on the bottom plate 31, and the wire fixing portion 23 is arranged on the core 11 to sandwich the core 11 between the bottom plate 31 and the wire fixing portion 23 with the core contact surface 23F facing the core 11 (setting step). Note that only the wire fixing portion 23 is schematically shown as the single-core wire 20 in FIGS. 10 to 12, considering the viewability of the figures.

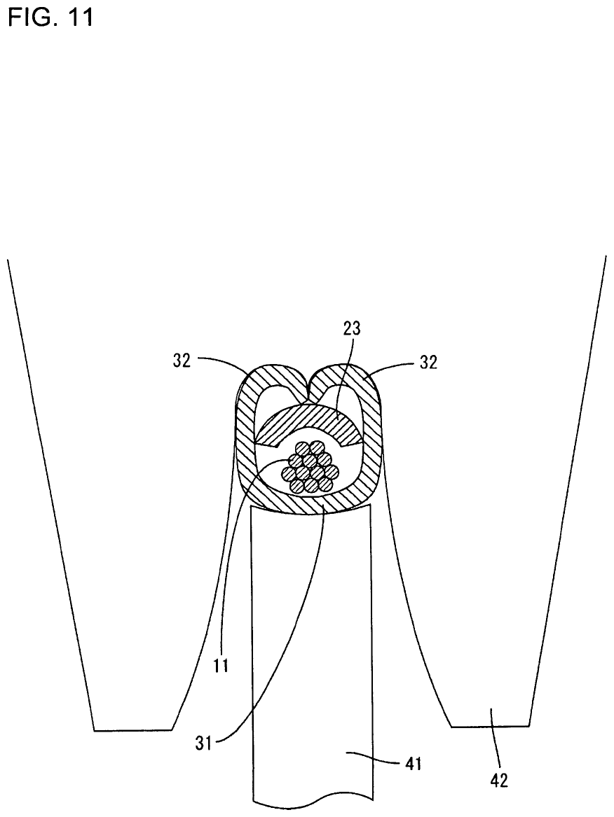

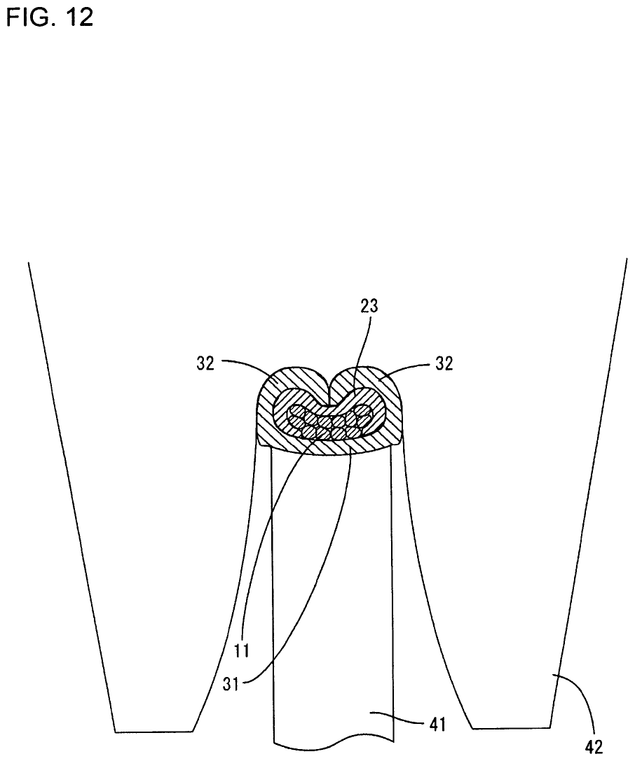

Subsequently, the crimper 42 is lowered toward the splice terminal 30. Then, the wire barrels 32 respectively butt against the barrel pressing wall 43 to be gradually curved inwardly from the end edges 32E. When the crimper 42 is lowered farther, the wire barrels 32 are curved more inwardly and are butted against each other to bite into the wire fixing portion 23, as shown in FIGS. 11 and 12. The wire fixing portion 23 also is curved to wind around the core 11 in conformity with the curved shape of the wire barrel portions 32. In this way, the splice terminal 30 is crimped to both the core 11 and the wire fixing portion 23 (crimping step).

At this time, the wire fixing portion 23 is interposed between the core 11 and the wire barrels 32. Thus, the core 11 cannot protrude from butting parts of the wire barrels 32 according to stress deformation of the splice terminal 30.

As described above, the harness 1 is provided with the wire 10 including the core 11 constituted by the metal strands and the insulation coating 12 coating the core 11. The single-core wire 20 includes the body 21 and the wire fixing portion 23 extending from the body 21 and arranged to cover the core 11. The splice terminal 30 includes the bottom plate 31, the core 11 arranged on the bottom plate 31, and the wire barrels 32 extending from the bottom plate 31 and wound from outside the wire fixing portion 23. According to the above configuration, the wire fixing portion 23 of the single-core wire 20 is interposed between the core 11 and the wire barrels 32. Thus, the core 11 cannot protrude from the butting parts of the wire barrels 32.

Further, the wire fixing portion 23 includes the thick portion 23B extending along the circumferential direction of the core 11 and having a larger thickness than other parts. According to the configuration with the wire fixing portion 23 including the thick portion 23B, the part of the core 11 covered with the thick portion 23B serves as the high compression portion 11H compressed at a higher compression ratio than the other parts. In the high compression portion 11H, the core 11 is compressed at a high compression ratio so that the oxide film formed on the surface of the core 11 is broken to expose the new surface of metal. By the contact of the splice terminal 30 and the wire fixing portion 23 with this new surface, desired electrical connection is obtained between the core 11, the single-core wire 20 and the splice terminal 30. On the other hand, since the core 11 is compressed with a lower compression force than in the high compression portion 11H in the other parts, the breakage of the core 11 is suppressed.

If the high compression portion 11H is present in the core 11 as just described, the core 11 easily protrudes in this high compression portion 11H. To avoid this, the wire fixing portion 23 is interposed between between the core 11 and the wire barrels 32.

Further, the manufacturing method for the harness 1 as described above includes the setting step of placing the wire fixing portion 23 on the core 11 after the core 11 is placed on the bottom plate 31 and the crimping step of winding the wire barrel portions 32 around the core 11 from outside the wire fixing portion 23 after the setting step. According to this configuration, it can be avoided in the crimping step that the core 11 protrudes from the butting parts of the wire barrels 32 since the wire fixing portion 23 is interposed between the wire barrels 32 and the core 11.

The invention is not limited to the above described and illustrated embodiment. For example, the following various modes also are included.

One part adjacent to the coupling 22 serves as the thick portion 23B having a larger thickness than the remaining part (thin portion 23A) on the tip side in the wire fixing portion 23 in the above embodiment. However, the configuration of the thick portion is not limited to that of the above embodiment and, for example, one part on the tip side may serve as a thick portion. Alternatively, a central part between an end edge on the body portion side and an end edge on the tip side may serve as a thick portion.

Although the body 21 is a round bar in the above embodiment, the shape of the body is not limited to that of the above embodiment and, for example, may be a square bar.

### LIST OF REFERENCE SIGNS

1 . . . harness
10 . . . wire
11 . . . core
12 . . . insulation coating
20 . . . single-core wire (connecting conductor)
21 . . . body
23 . . . wire fixing portion
23B . . . thick portion
30 . . . splice terminal (crimping terminal)
31 . . . bottom plate (bottom wall)
32 . . . wire barrel (barrel)

1. A wire connection structure, comprising:
a wire including a core constituted by a plurality of strands and an insulation coating covering the core;
a connecting conductor including a body and a wire fixing portion extending from the body and arranged to cover the core; and
a crimping terminal including a bottom wall, the core being arranged on the bottom wall, and two barrels extending from the bottom wall and wound from outside the wire fixing portion.

2. The wire connection structure of claim 1, wherein the wire fixing portion includes a thick portion extending along a circumferential direction of the core and having a larger thickness than other parts.

3. A harness manufacturing method for connecting a wire and a connecting conductor by a crimping terminal, the wire including a core constituted by strands and an insulation coating covering the core, the connecting conductor including a body and a plate-like wire fixing portion extending from the body, and the crimping terminal including a bottom plate, the core being arranged on the bottom wall, and two barrels extending from the bottom wall, comprising:
setting the core on the bottom wall;
setting the wire fixing portion on the core after the core is set on the bottom wall; and
winding the barrel around the core from outside the wire fixing portion after setting the wire fixing portion on the core.
